(19) United States
(12) Patent Application Publication
(10) Pub. No.: US 2016/0117704 A1
(43) Pub. Date: Apr. 28, 2016

(54) System and method for storing and retrieving objects of interest relevant to different audience profiles.

(71) Applicant: Satheesh Kumaresan Nair, Cupertino, CA (US)

(72) Inventor: Satheesh Kumaresan Nair, Cupertino, CA (US)

(21) Appl. No.: 14/922,158

(22) Filed: Oct. 25, 2015

Related U.S. Application Data
(60) Provisional application No. 62/068,228, filed on Oct. 24, 2014.

(51) Int. Cl. G06Q 30/02

(52) U.S. Cl. CPC G06Q 30/0204

(57) ABSTRACT

A computerized system and method for storing and retrieving objects of interest relevant to different audience profiles is described. An embodiment of the method includes publishing objects of interest relevant to certain audience (e.g., Web page, Blog post, Social networking group, Business networking group, TV/Radio program, News article, Event, Product/Service information, Store location, Store section etc.) by their providers (e.g., Web publisher, Social network, Business network, TV channel, Publication, Event organizer, Business marketer, Signage network etc.) or another system acting on behalf of such providers, wherein such objects include one or more attributes about their audience (e.g., geographical region or location, age group, gender, interests etc.), indexing and storing the objects in a database based on published audience attributes, receiving search request from an user or another system acting on behalf of an user for searching objects that matches an audience-based search criteria, performing a search in the database for objects that meets the search criteria, and presenting the list of matching objects to the search requestor.

### BACKGROUND OF THE INVENTION

1. Field of the Invention

The present invention relates to a system and method for storing and retrieving objects of interest relevant to different audience profiles, in particular, to a system and method for storing and searching objects of interest which relates to a specific audience using the audience profile data published by the providers of such objects. The need for a search system and method described in this invention exists for several reasons, such as, for information seekers to discover various objects of interest that engages people with certain demographic profile, or for advertisers to discover advertising inventory that reaches their target audience.

2. Description of Related Art

There are several search engines available today that enable users to search information which contains specific keywords, phrases or a logical combination of such criteria.

For information seekers wanting to discover objects of interest that engages a specific audience segment, the existing keyword-based search engines provide references to all documents that contain references to a search query. For example, a search query such as “Hispanic female San Jose” returns all documents that references different search terms in the query. The generic nature of such search engines do not allow information seekers to explicitly state their intent of retrieving only objects of interest that engages a specific population segment. The actual intent of the information seeker in the previous example could have been to discover objects of interest that engages Hispanic female population in the city of San Jose. Such objects (“audience objects”) may include web pages, blog posts, streaming videos, social networking groups, business networking groups, TV/Radio programs, news articles, events, promotions, product/service information and physical store locations, all that attracts or engages Hispanic female crowd in San Jose. The information seeker may want to search based on other attributes such as age, income, religion, education, occupation, marital status, opinions, hobbies, beliefs, interests and any other population characteristics used to identify population segments. There are other existing systems that hosts specific category of objects such as TV program guides and event management systems, which allows searching objects belonging to the respective category only.

There are other methods and systems that rely on automated collection of temporal, spatial and social interactions between users and networked devices to correlate such events and present contextually relevant media objects to users.

The main objective of targeted advertising is to ensure that advertisements are embedded within audience objects that catches the attention of specific population segments (“Target audience”). Advertisement placeholders are embedded within audience objects by providers of such objects (“Publishers”) and sold to purchasers who need such placeholders (“Advertisers”) for placing their advertisements. Examples of such placeholders include Internet advertising units, mobile advertising units, program airtime, movie screen time, print advertising units, billboard dimensions and digital signage units.

The target audience is defined by one or more attributes of human populations, which includes all attributes that are commonly known as demographics and psychographics. Such attributes may include geographical region, age, gender, income, ethnicity, nationality, religion, education, occupation, marital status, opinions, hobbies, beliefs, interests and any other population characteristics used to identify population segments.

Advertisers who purchase advertising placeholders embedded within audience objects, seek high performance from their advertisements for the money they spend. The performance is related to the achievement of their advertising goals, such as generation of higher demand for their products and services from the audience targeted through advertisement. The performance of an advertisement depends on several factors including the percentage of target audience reached, placement position, quality of creative and timing of advertisement. The percentage of target audience reached takes precedence over the other factors because the advertisement has to first reach maximum number of viewers belonging to target audience, before any of the other factors can influence its performance.

There are audience data providers, who collects audience data from different objects that engages audience, such as websites, TV programs and events. The accuracy of such audience data is either limited to the representative sample or the methods and techniques used for data collection. The data sets available from such data providers shows audience data for selected media segments and objects. However, none of them provide a system that allows advertisers to conduct a search for all such objects, which engages certain target audience.

There are existing digital advertising systems that can automatically select a relevant advertisement from a set of available advertisements and render it on web pages browsed by an Internet user. The selection process used by such systems combines one or more targeting rules specified by advertisers who submitted advertisements and matches them with the demographic identity of Internet user, estimated from user's browsing history, search keywords, known interests, location and other criteria. Still other systems matches targeting rules specified by advertisers with the semantic context of web pages, including keywords contained in them. Such techniques are applicable only for advertising on digital media and the relevancy of advertisements are limited to the accuracy of methods used for estimation and semantic analysis.

When a digital advertising impression has to be served and no relevant advertisements are found within an advertising system, there are existing methods to communicate with other advertising systems in real time and find a relevant advertisement. Even though such methods increases the available audience objects for advertisers and advertising sales for publishers, the techniques used for estimating the relevancy remains the same.

Even though audience attributes associated to audience objects are the same across different media segments, the advertising placeholders that are sold differs between them. The existing advertising systems that sell advertising placeholders to advertisers handle audience objects from specific media segments, such as Internet, Mobile, Television, Print or Out-of-Home. For example, Internet advertising systems supports selling of Internet advertising units, where as a Television advertising system supports selling of airtime and sponsorships.

However, this has led to the fragmentation of audience objects and associated audience across several advertising systems, such as ad networks, ad exchanges, social networks and standalone providers, which can individually provide targeting capabilities within a fragmented subset only. With the emergence of new advertising systems, the audience is getting even more fragmented. The fragmentation is much more for traditional media segments, where most providers independently sell their audience objects.

It is apparent that a need exists for a system and method that allows providers of audience objects existing on either real or virtual worlds to publish their information along with audience data, and provide a common search engine for information seekers and advertisers to discover audience objects that matches an audience-based search criteria.

### SUMMARY

The present invention provides a system and method for publishing objects of interest that carries an affinity to certain audience (hereafter called audience objects) identified by a plurality of audience attributes (audience profile) and enabling the discovery of published audience objects using a common search criteria based on audience attributes (hereafter called audience searching criteria).

An objective of this invention is to provide a system and method for providers or owners of such audience objects (hereafter called publishers) to submit them into a search engine and index those audience objects using a plurality of audience attributes to facilitate their discovery by advertisers and other information seekers.

It is also an objective of this invention to provide a system and method for advertisers, information seekers or other computer systems acting on their behalf (hereafter called search requestors) to search audience objects based on an audience searching criteria.

Another objective of this invention is to provide an application programming interface (hereafter called API) for other computer systems acting on behalf of publishers to input any audience objects accessible to such systems into an embodiment of the search engine described in this invention and index those audience objects based on one or more population attributes to facilitate their discovery by search requestors.

### BRIEF DESCRIPTION OF THE DRAWINGS

FIG. 1 is a diagram illustrating the search engine for storing and searching different types of audience objects that satisfies a search query based on audience criteria.

FIG. 2 illustrates an example embodiment of the data structure for a standardized audience object that can represent both real world and virtual entities.

FIG. 3 shows examples of standardized audience objects.

FIG. 4 is an upper level block diagram of an embodiment of the system which is capable of supporting the method of the present invention and is shown as three subsystems.

FIG. 5 is a functional block diagram of an embodiment of the first subsystem that facilitates submission of standardized audience objects into the search engine.

FIG. 6 is a functional block diagram illustrating the submission of audience objects using a user interface by publishers.

FIG. 7 is a schematic representation of an example graphical user interface (GUI) displayed on a computer screen for submitting an audience object into the search engine.

FIG. 8 is a functional block diagram illustrating the submission of audience objects using an API by other systems.

FIG. 9 is a functional block diagram illustrating an associative data structure for mapping different audience search criteria to standardized audience objects that share similar attributes.

FIG. 10 is a functional block diagram of an embodiment of the second subsystem that facilitates the indexing of audience objects based on their audience attributes.

FIG. 11 is a functional block diagram of an embodiment of the third subsystem that facilitates the searching of audience objects.

FIG. 12 is a schematic representation of an example graphical user interface (GUI) displayed on a computer screen for specifying the audience search criteria.

FIG. 13 is a schematic representation of an example graphical user interface (GUI) displayed on a computer screen with search results consisting of audience objects.

### DETAILED DESCRIPTION

The following is a detailed description of illustrative embodiments of the present invention. As these embodiments of the present invention are described with reference to the aforementioned drawings, alternate embodiments of the system and method may become apparent to those skilled in the related fields of the present invention. All variations and modifications in such alternate embodiments that rely upon the disclosure of this invention are considered to be within the spirit and scope of the present invention. For example, audience objects that are returned as search results by a search engine could be acquired for audience-based indexing through other methods, such as by calling methods in an API implemented by other systems or by crawling Internet URLs to parse, identify and generate audience objects. Likewise, the results of searching audience objects maybe consumed by other computer systems that are acting on behalf of search requestors, without actually presenting such results in a user interface. Hence, these descriptions and drawings are not be considered in a limiting sense as it is understood that the present invention is in no way limited to the illustrated embodiments.

The present invention provides a system and method for searching audience objects using a common audience searching criteria. In an exemplary embodiment, the system and method include (1) storing audience objects and their audience attributes from publishers using a standardized data structure, (2) indexing the audience objects in a search engine to facilitate their discovery based on different audience attributes, (3) providing a search engine interface for search requestors to search for audience objects that satisfies an audience searching criteria.

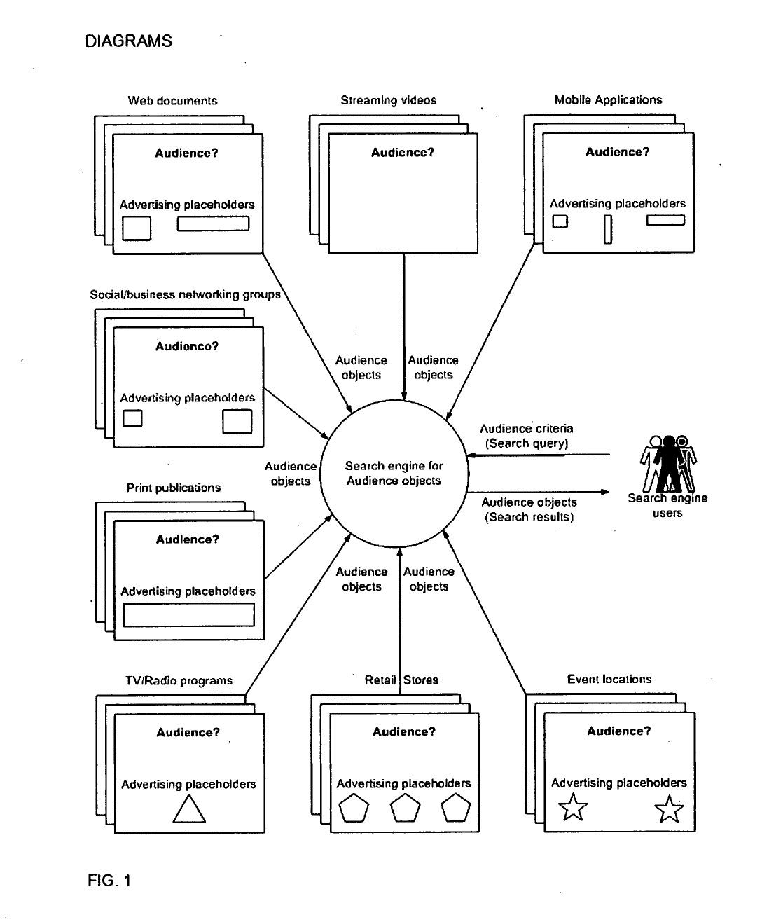

FIG. 1 is a high level illustration of the search engine for storing and searching different types of audience objects that satisfies a search query based on audience searching criteria. On one side, the search engine receives and stores different types of audience objects, such as web documents, streaming videos and mobile applications from publishers. On the other side, the search engine facilitates discovery of audience objects by search requestors. Different audience objects received by the search engine can contain one or more advertising placeholders. Audience objects can also be received without any advertising placeholders also, as shown in the example of streaming video. Advertising placeholders from different publishers are shown to have different form factor for the purpose of illustration. For example, advertising placeholders in web documents can refer to Internet advertising units expressed in pixel dimensions, whereas advertising placeholders in TV/Radio programs can refer to time slots for playing advertisements expressed in seconds. In a preferred embodiment of this invention, the unified searching and discovery of different types of audience objects is achieved by indexing them based on common audience attributes only. The indexing method described in this invention does not take into consideration different form factors associated to advertising placeholders or other attributes that are specific to a certain type of audience objects. When the user fetches details about different audience objects returned by the search engine query, the detailed data set can have variations depending on the type of audience object.

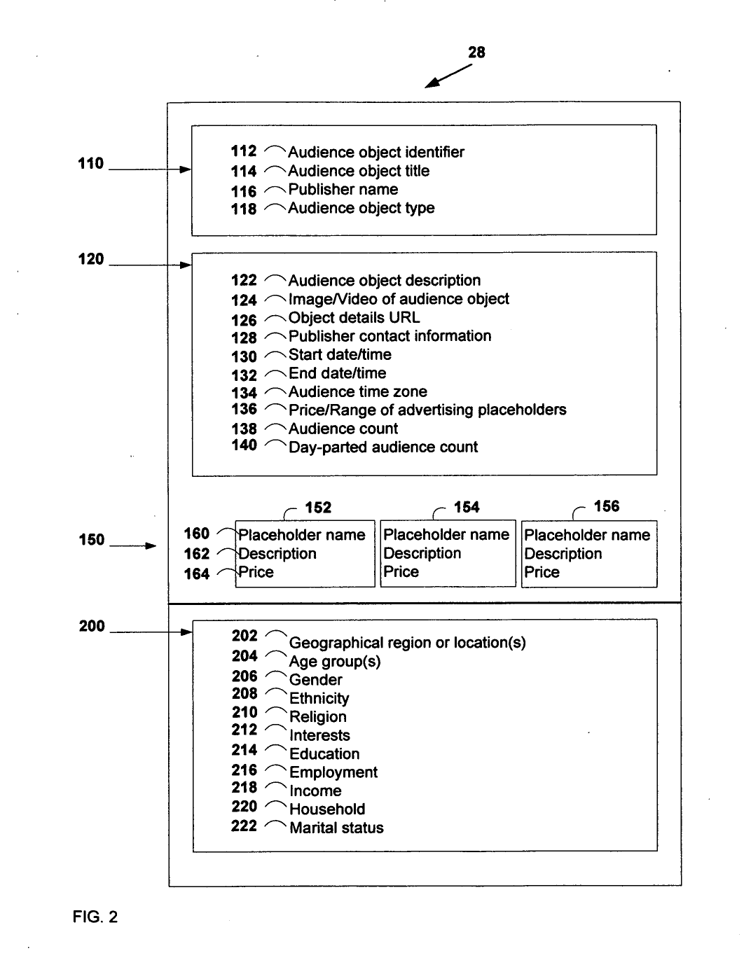

FIG. 2 illustrates an example embodiment of the data structure for a standardized audience object 28. The data structure comprises of three data blocks 110, 120 and 150 shown at the top, which comprise of general attributes about an audience object not related to its audience. The data block shown at the bottom 200 comprise of attributes related to the audience of audience object, which are used by the search engine for indexing an audience object. Other variations of the illustrated embodiment of the present invention may use different combinations of data fields and blocks to represent an audience object in a standardized format.

The three general attribute blocks shown in FIG. 2, includes a mandatory block 110, which at the very minimum, comprise of the audience object identifier 112, title of audience object 114, name of publisher 116 and audience object type 118. The audience object type 118 is used to identify the specific category of audience object. Examples of type includes blog post, social networking group, mobile app, event, television programs, movie shows and retail store.

The second block from the top 120 shows other optional attributes about an audience object that publisher may provide, which includes, without limitation, audience object description 122, image/video of audience object 124, audience object URL 126, publisher contact information 128, start date/time 130, end date/time 132, audience time zone 134, price or price range of advertising placeholders 136, audience count 138 and day-parted audience count 140. The audience object URL 126 points to an Internet resource where further details about the referenced audience object can be obtained. The price or price range of advertising placeholders 136 embedded within the audience object can use different units for pricing such as daily, monthly and CPM (Cost-Per-Mille). The audience count 138 can be for the entire lifecycle of the audience object or for specific duration, such as daily or monthly. The day-parted audience count 140 can include multiple values that specify audience count for different time slots during a day.

The third block from the top 150 shows one or more advertising placeholders that publisher may provide within an audience object. While the illustrated embodiment shows three such placeholders 152, 154 and 156, publishers may submit audience objects either with no placeholders or containing a different count of placeholders. Every placeholder may include, without limitation, placeholder name 160, description 162 and price 164. Such advertising placeholders may also include other attributes such as placement, advertising units and day part that shows the specific time slot during a day.

The data block shown at the bottom 200 is mandatory for different embodiments of the present invention. It comprises one or more audience attributes that are used by the search engine to index an audience object, which includes, without limitation, geographical region or location(s) 202, age group 204, gender 206, ethnicity 208, religion 210, interests 212, education 214, employment 216, income 218, household 220 and marital status 222. Certain audience objects can have multiple occurrences of the data block 200, where each occurrence corresponds to an audience segment. An example embodiment of the present invention would use an associative data structure for implementing 200, where audience attribute names are mapped to one or more attribute values. For example, a set of display screens managed by an Out-of-Home (“OOH”) network are positioned at various pet clinics that are located in the cities of San Jose, Cupertino and Mountain View. Since those display screens engages certain audience visiting the pet clinics, the OOH network can submit them as an audience object into the search engine and the associative data structure 200 would contain the following entries.

Household: “With pets”
Interests: “Pet care”, “Pet grooming”

### Locations: “San Jose”, “Cupertino”, “Mountain View”

In a minimal embodiment of the present invention, audience objects would consist of the mandatory data block 110 and audience data block 200 only. The minimal embodiment would be useful for search requestors to discover various types of audience objects that engages a specific audience, where such users are not seeking advertising placeholders or other details about the audience object.

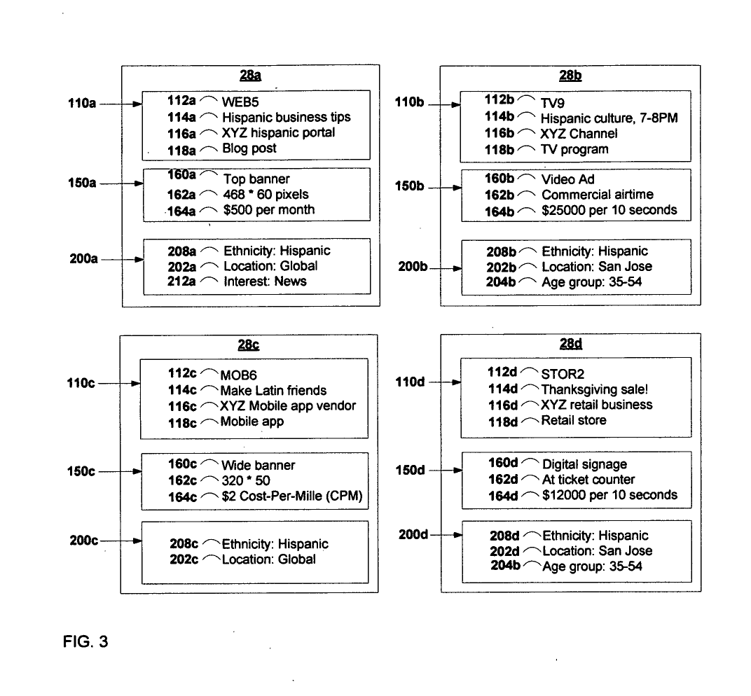

FIG. 3 shows examples of four standardized audience objects whose types are Blog post 28a, TV program 28b, Mobile app 28c and Retail store 28d types. All four audience objects are shown with the mandatory data blocks (110, 200) and one advertising placeholder block 150. The example shows how the same fields in the data structure for standardized audience object 28 can be used to store data from disparate types of audience objects. The mandatory block 200 for the four example audience objects shows the same value Hispanic for audience attribute Ethnicity, which means all those objects engages Hispanic population. Each audience attribute included with an audience object can have one or many values. For example, an audience object that represents a TV program can engage audiences from multiple cities and belonging to multiple ethnicities. All other methods of combining audience attributes and associating the resultant data block 200 to an audience object is included within the scope of this invention. For example, an audience object may engage Caucasian (ethnicity) single (marital status) females (gender) 35+ (age group) and Hispanic (ethnicity) females (gender) 18+ (age group).

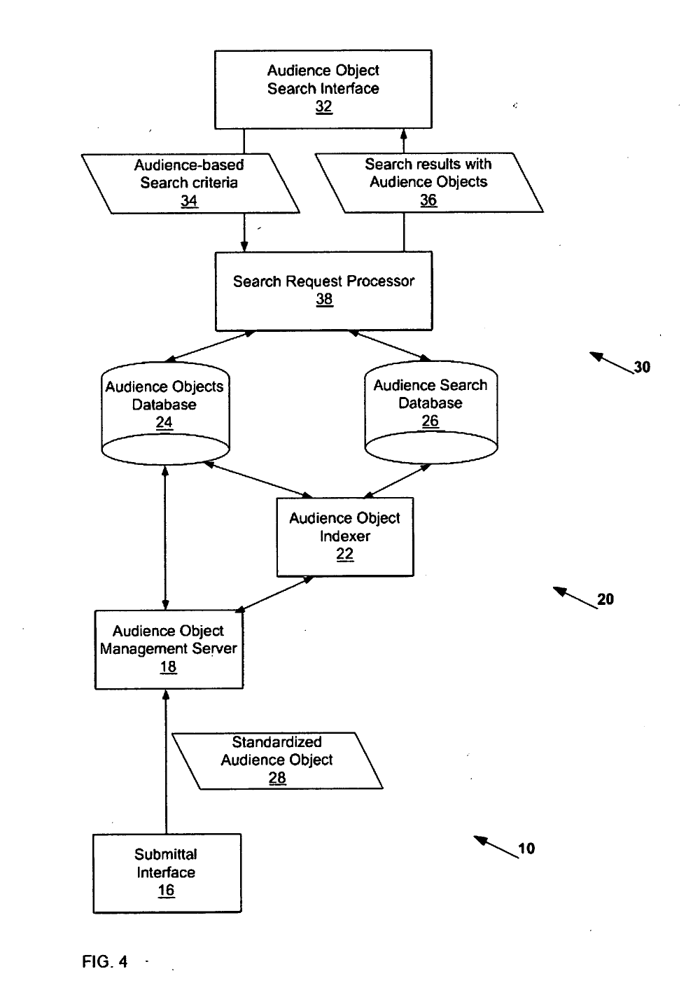

FIG. 4 is an upper level block diagram of an embodiment of the system which is capable of supporting the method of the present invention. The system is shown divided into three subsystems; these are designated as audience object submission 10, audience object indexing 20 and audience object searching 30. Minimal embodiments of each subsystem will be described in more detail below.

The first subsystem audience object submission 10 allows publishers to input a standardized audience object 28 into an audience object management server 18 using a submittal interface 16. Audience object management server stores received objects in an audience objects database 24.

The second subsystem audience object indexing 20 includes an audience object indexer 22 and audience search database 26. The audience object indexer may either receive the objects directly from audience object management server 18 or reads them from an audience objects database 24. The audience object indexer reads various data attributes from every audience object and indexes them based on one or more attributes that defines their audience. The indexed objects are further stored in the audience search database 26.

The third subsystem audience object searching 30 allows search requestors or other systems acting on their behalf, to search for audience objects using an audience searching criteria 34. An audience object search interface 32 presents some form of interface to a requesting entity, which allows specifying one or more audience attributes as the search criteria. The search criteria from the requesting entity is received by a search request processor 38, which in turn, queries the audience search database 26 for audience objects that matches the requested audience attributes. The search request processor 38 further returns the search results with matching audience objects 36, to the audience object search interface 32 used by the requesting entity.

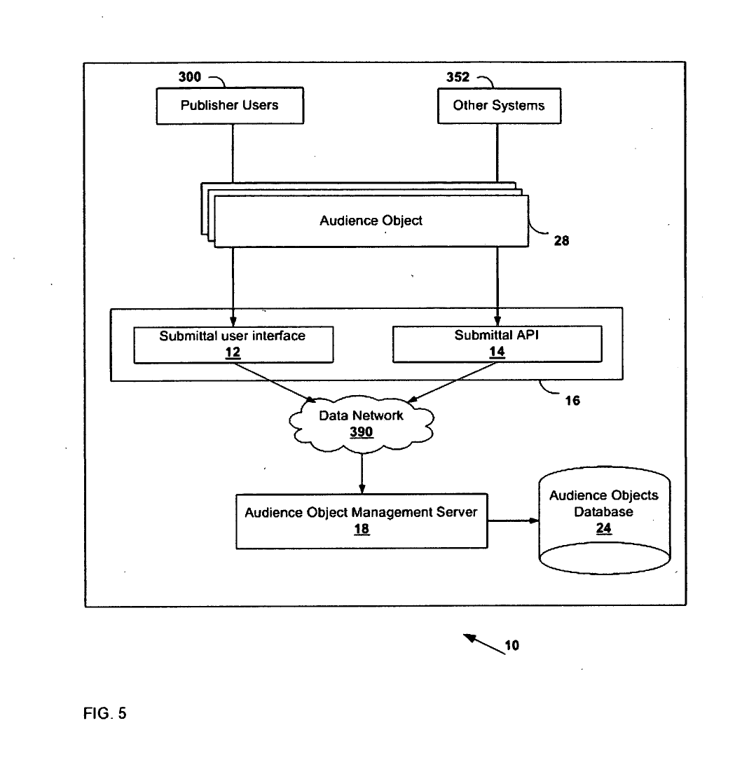

FIG. 5 is a functional block diagram of an embodiment of the first subsystem audience object submission 10 that facilitates submission of standardized audience objects 28 into the search engine. The illustrated embodiment shows two methods for implementing submittal interface 16; submittal user interface 12 and submittal API 14. Submittal user interface 12 allows publisher users 300 to manually input audience objects using some form of user interface such as a graphical user interface (GUI) or command line interface (CLI). Submittal API 14 allows other systems 352 to input audience objects accessible to such systems in a programmatic manner. The submitted objects are transferred over a data network 390 to the audience object management server 18, which stores the objects in audience objects database 24.

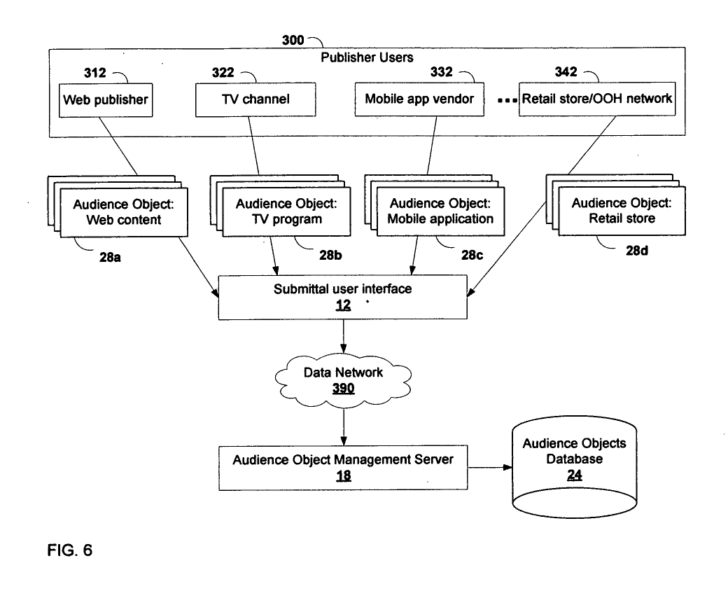

FIG. 6 is a functional block diagram illustrating examples of publishers 300 submitting audience objects using the submittal user interface 12. The illustrated embodiment shows a web publisher 312 submitting web content 28a, a TV channel 322 submitting TV programs 28b, a mobile application vendor 332 submitting mobile applications 28c and a retail store operator or an OOH signage network operator 342 submitting retail stores 28d. The standardized audience objects are then transferred over a data network 390 to the audience object management server 18 that stores the objects in audience objects database 24. Other examples of publisher users that can submit audience objects includes, without limitation, web publisher submitting streaming videos and blog posts, social/business networking group owner submitting social/business groups, radio station submitting radio programs, movie producer or distributer submitting movies, news agency submitting news articles and an out-of-home display network submitting specific sections within a retail store that offers products or services relevant to certain audience.

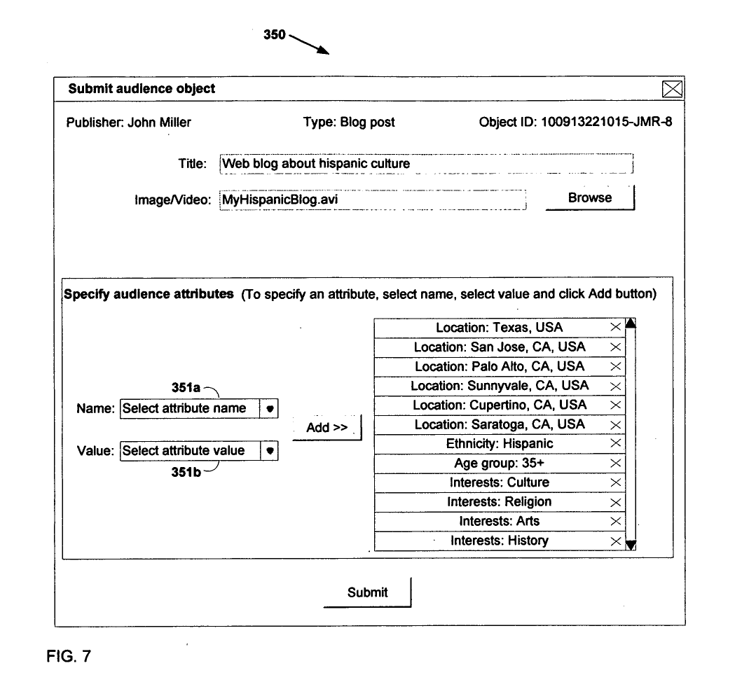

FIG. 7 is a schematic representation of an example GUI 350 displayed on a computer screen for submitting an audience object into the search engine. It shows the example of a publisher submitting a blog post about Hispanic culture as an audience object into the search engine described in this invention. The illustrated GUI shows only a few fields from the standardized data structure for audience object 28 and does not include any advertising placeholders. The combo box field for selecting attribute name 351a shows different audience attributes such as Location, Ethnicity, Gender, Age group and Interests. The combo box field 351b shows all possible values associated to the selected attribute name 351a. Alternate embodiments of the present invention could provide different set of fields or follow a different scheme in the GUI for submitting audience objects. The GUI for submitting audience objects into the search engine can also be embedded into other GUI systems used by publishers as a user interface widget. Examples of such systems includes, without limitation, web publishing systems, event management systems and content management systems.

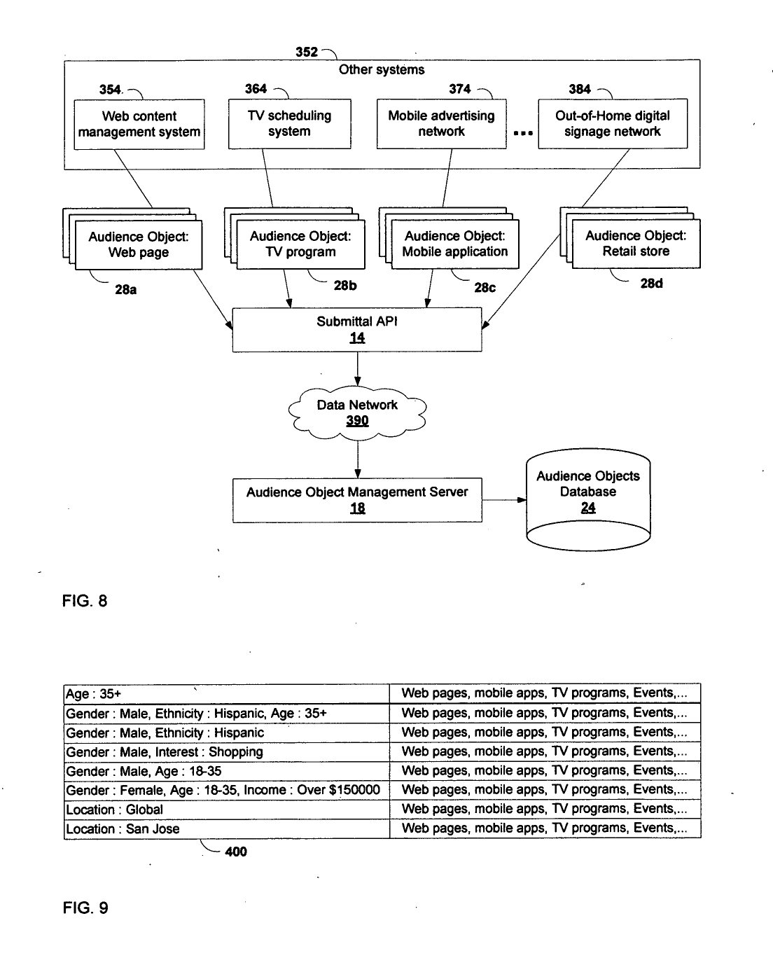

FIG. 8 is a functional block diagram illustrating examples of other systems 352 submitting audience objects using a submittal API 14. The illustrated embodiment shows a web content management system (CMS) 354 submitting web pages 28a, a TV scheduling system 364 submitting TV programs 28b, a mobile advertising network 374 submitting mobile applications 28c and an Out-of-Home digital signage network 384 submitting retail stores 28d. The standardized audience objects are then transferred over a data network 390 to the audience object management server 18 that stores the objects in audience objects database 24. Other examples of systems that can submit audience objects using a submittal API includes, without limitation, Internet advertising exchanges, Internet advertising networks, audience measurement and tracking systems, social networking systems, business networking systems, digital signage systems, event management systems, audience measurement systems and enterprise systems. In alternate embodiments of the present invention, audience objects may be submitted either on a real-time or non-real-time basis. For example, a real-time traffic monitoring system may submit an audience object that represents a digital billboard visible to highway commuters whenever the system detects traffic blocks in the vicinity of billboard location.

All audience objects received by the search engine described in this invention, either through the submittal user interface or submittal API, are indexed by the second subsystem audience object indexing 20. In a preferred embodiment of the present invention, the audience object indexer 22 uses an inverted index data structure for mapping every combination of audience attributes associated to audience objects with corresponding audience object identifiers 112. The inverted indexes are further stored in the audience search database 26. Alternate embodiments may store the entire audience object itself in the audience search database. The different combinations of audience attributes for which indexes are stored corresponds to all possible audience searching criteria 34 that could be requested by a search engine user.

FIG. 9 illustrates an example embodiment of the inverted index data structure 400 for mapping different combinations of audience attributes to standardized audience objects that engages audience with similar attributes. The audience objects mapped for each audience criteria corresponds to different types, such as web pages, mobile apps, TV programs and Events. In a preferred embodiment of the present invention, the ordering of audience objects mapped against every combination of audience attributes would be a function of the similarity found between the mapped attributes with that of the audience attributes associated to audience objects. For example, if an audience object A is associated to audience (Ethnicity: Hispanic, Gender=Male) and another audience object B is associated to audience (Ethnicity: Hispanic), following inverted indexes are generated.

### Ethnicity: Hispanic, Gender: Male→A, B

### Ethnicity: Hispanic→B, A

### Gender: Male→A

In the first inverted index above, A precedes B because both attributes that are mapped (Ethnicity and Gender) matches with the attributes of A but only one matches with that of B. Similarly for the second inverted index, there is an exact match with the only attribute (Ethnicity) associated to B, so B precedes A. For the third inverted index, only object A contains the matching value for attribute Gender.

In alternate embodiments of the present invention, the actual algorithm used for ordering audience objects associated to a given combination of audience attributes can be different. For example, a weight factor maybe associated to different audience attributes associated to audience objects. The weight factor may further be used by the indexing subsystem to determine the order of precedence of different audience objects with similar audience attributes. All variations and modifications in such alternate embodiments that serves the intent of ordering audience objects by their relative capability in engaging a specific audience segment (identified by a combination of audience attributes) are considered to be within the spirit and scope of the present invention.

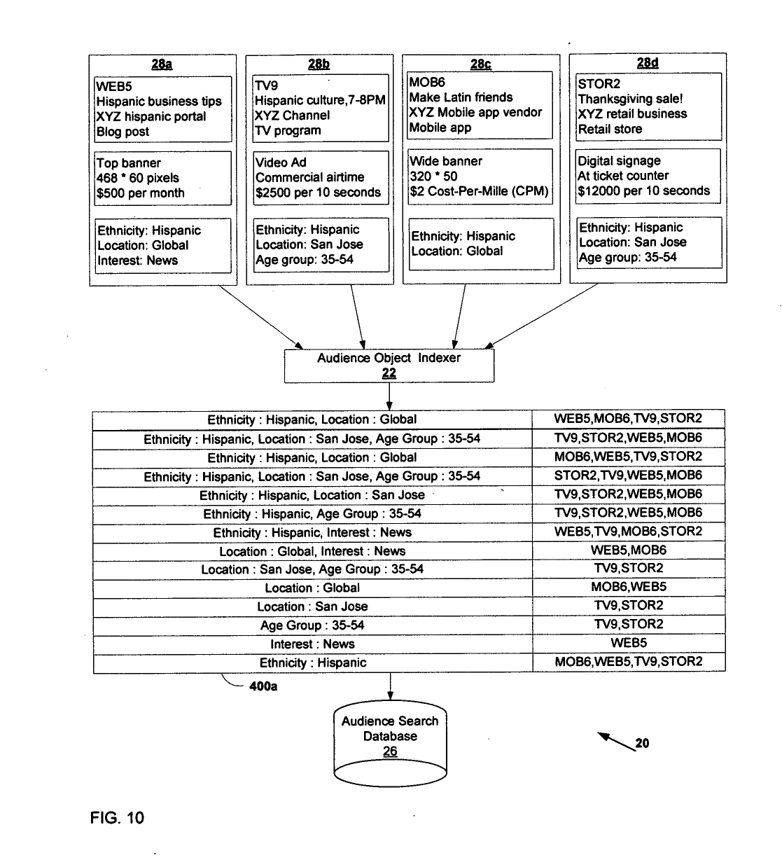

FIG. 10 is a functional block diagram that shows an example embodiment of the second subsystem audience object indexing 20, which facilitates the indexing of audience objects based on their audience attributes. The example illustrates using an inverted index data structure 400a for mapping different combinations of audience attributes associated to four different audience objects with corresponding audience object identifiers. The same set of example audience objects shown in FIG. 3 belonging to Internet 28a, Television 28b, Mobile 28c and Physical store 28d types are used for illustrating the mapping methodology. The audience object indexer 22 processes each audience object, generates the inverted indexes and stores the mapping in audience search database 26.

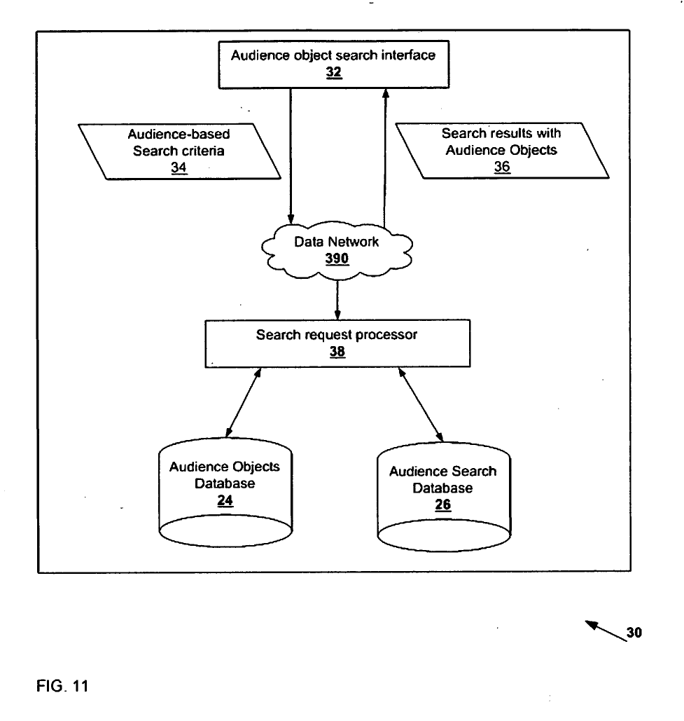

FIG. 11 is a functional block diagram of an embodiment of the third subsystem audience object searching 30 that facilitates the searching of audience objects. A minimal embodiment of audience object searching 30 would consist of an audience object search interface 32, search request processor 38 and an audience search database 26. The advertisers, information seekers or other computer systems requiring to search for audience objects (“Search requestors”) submits a search query or audience search criteria 34 using the audience object search interface 32. Different embodiments of the search interface includes, without limitation, a graphical user interface (GUI), command line interface (CLI) and an API. The audience search criteria consists of one or more attributes that defines an audience, which includes geographical region or location, age, gender, income, ethnicity, nationality, religion, education, occupation, marital status, opinions, hobbies, beliefs, interests and any other audience-based classification possible for audience objects. The search interface may also allow combining or widening the scope of audience attributes submitted in search criteria, using other operations and expressive syntax which includes, without limitation, logical AND, logical OR, logical NOT and regular expressions. The audience search criteria 34 is transferred over a data network 390 to the search request processor 38.

The search request processor 38 receives audience search criteria 34 from any search requestor and queries the audience search database 26 for audience object identifiers that matches the requested audience search criteria. For every matching audience object identifier found, the search request processor fetches the corresponding audience object from the audience objects database 24. In alternate embodiments, the search request processor may directly retrieve matching audience objects from the audience search database itself. The search request processor 38 further returns the search results with matching audience objects 36 to the audience object search interface 32 used by the search requester.

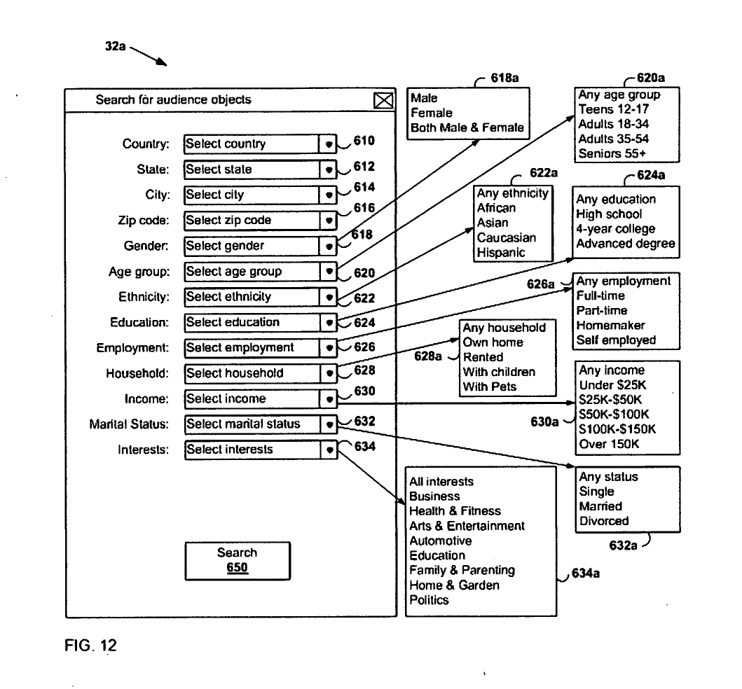

FIG. 12 is a schematic representation of an example GUI 32a displayed on a computer screen for the search requestor to specify the audience search criteria. The search request GUI or other search request interfaces included in alternate embodiments of the present invention could allow different set of audience attributes or follow a different user interface scheme. The example GUI shows multiple combo box fields for entering the audience search criteria 34, which includes country 610, state 612, city 614, zip code 616, gender 618, age group 620, ethnicity 622, education 624, employment 626, household 628, income 630, marital status 632 and interests 634. The diagram also shows example values for few combo box fields, which includes gender 618a, age group 620a, ethnicity 622a, education 624a, employment 626a, household 628a, income 630a, marital status 632a and interests 634a. The search requestor user selects values for one or more combo box fields and clicks on search button 650.

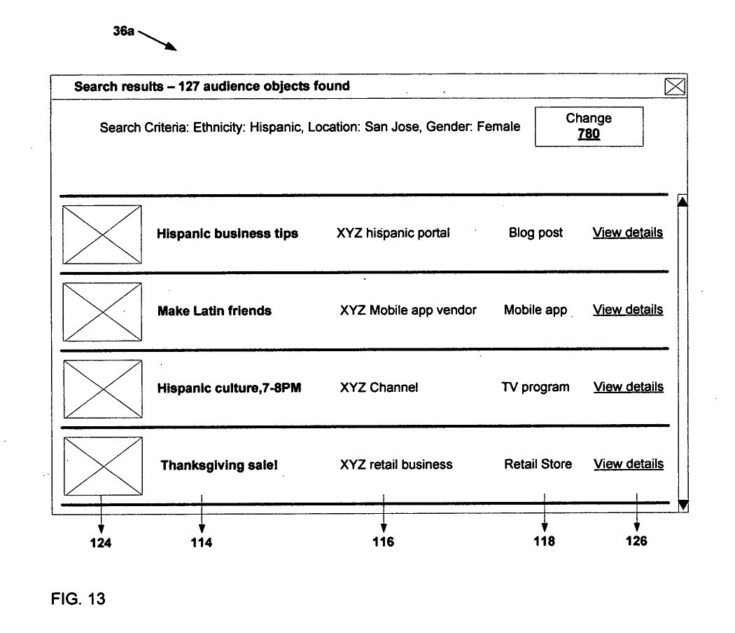

FIG. 13 is a schematic representation of an example GUI 36b displayed on a computer screen with search results consisting of audience objects. For every audience object listed in search results, the example GUI displays an image/video of the audience object 124, name of audience object 114, name of publisher 116, audience object type 118 and an object details URL 126. The object details URL 126 can be a hyper-link that leads the search requestor to another web page or computer system that shows further details about a specific audience object. The search results GUI or other search result interfaces included in alternate embodiments of the present invention could display a different set of data fields for the returned audience objects.

1. A method comprising:
receiving request from a publishing entity to enable discovery and distribution of objects of interest that carries an affinity to specified audience (“audience objects”), the request comprising of audience objects and their audience data, the audience data comprising a plurality of attributes that identifies a target population, which includes geographical region, age, gender, income, ethnicity, nationality, religion, education, occupation, marital status, opinions, hobbies, beliefs, interests and any other attributes used to identify audience segments; storing and indexing said audience objects based on the said audience data; searching and presenting stored audience objects to search requestor entities belonging to or representing the specified audience.

2. The method of claim 1 further comprising: enabling the discovery and distribution of different types of audience objects from both real and virtual worlds, the possible object types comprising of Internet web pages, blog posts, social networking groups, business networking groups, events, mobile applications, streaming videos, television programs, radio programs, retail stores, retail store sections, news articles, movie shows, product/service information and other object types that are known to the publishing entity as related to or carrying affinity to certain types of audience; and the said audience objects are either owned, produced, managed, operated or controlled by the publishing entity.

3. The method of claim 1 further comprising: enabling the discovery and distribution of audience objects submitted by different types of publishing entities, the possible types of publishing entity comprising of web publishers, bloggers, business marketers, mobile application vendors, event organizers, video publishers, television channels, radio stations, out-of-home digital signage networks, print publishers, movie exhibitors, movie producers, advertising agencies, retail store operators or owners, media resellers, other systems and any other real world or virtual entity who possess such audience objects.

4. The method of claim 3 further comprising: enabling the discovery and distribution of said audience objects submitted by other systems, wherein other systems include content management systems, event management systems, advertising networks, advertising exchanges and other computer software systems that handles said audience objects from a plurality of publishers.

5. The method of claim 1 further comprising: presenting of stored audience objects is triggered when a search requestor entity claiming to have similar audience attributes as that of the stored audience objects submits a search request, the search request comprising a plurality of audience attributes that identifies the search request which includes geographical region, age, gender, income, ethnicity, nationality, religion, education, occupation, marital status, opinions, hobbies, beliefs, interests and any other population characteristics used to identify audience segments.

6. The method of claim 5 further comprising: the submitting of search request by a search requestor entity, wherein the search requestor entity includes information seekers, advertisers, devices or other systems acting on behalf of a real world user.

7. The method of claim 5 further comprising: generating and presenting search results containing audience objects with similar audience attributes as specified in the search request to the search requestor entity, each search result data comprising a plurality of attributes that describes the audience object, which includes, without limitation, an object identifier, publisher identifier, object type and object locator.

8. The method of claim 7 further comprising: presenting audience objects with an object identifier, wherein the object identifier comprises one of a textual description, an image, a video or a combination thereof, which identifies the audience object; presenting audience objects with a publisher identifier, wherein the publisher identifier comprises one of a textual description, an image, a video or a combination thereof, which identifies a publisher; presenting audience objects with an object type, wherein the object type comprises one of a textual description, an image, a video or a combination thereof, which identifies a type of audience object; presenting audience objects with an object locator, wherein the object locator comprises of a Uniform Resource Locator (URL) of another resource with further details about said audience object and other options such as purchasing or downloading the audience object or other entities related to audience object.

9. A system comprising: hardware, including at least by a computer processor for executing program logic and a storage medium for storing program logic for execution by the processor, the program logic comprising: a public search engine for storing and retrieving audience objects based on their affinity to published audience segments; the said search engine comprising of an audience object management unit, search request processor unit and a search result response unit; the audience object management unit comprising of program logic that implements an interface for publishing entities to manage their audience objects and associated audience data required by the said search engine; the search request processor unit comprising of program logic for receiving search request from a search requestor entity and causes said search engine to execute a search for audience objects that satisfies an audience-based searching criteria; a search result response unit comprising of program logic for generating and presenting search results containing audience objects determined by the said search engine as satisfying the search criteria to the search requestor entity.

10. The system of claim 9 further comprising: the interface for publishing entities implements at least one of a command line interface (CLI), a graphical user interface (GUI), an API or a combination thereof, which enables publishing entities to execute different operations for managing their audience objects and associated audience data required by the said search engine.

11. The system of claim 10 further comprising: the interface supports different operations which includes, without limitation, creating, updating and deleting of audience objects and their associated audience data, wherein the execution of said operations can affect the search results generated by the said search engine for related audience searching criteria.
